(19) United States
(12) Patent Application Publication
(10) Pub. No.: US 2011/0271782 A1
(43) Pub. Date: Nov. 10, 2011

(54) OPERATING UNIT FOR VEHICLES DRIVEN BY AN ELECTRIC MOTOR, IN PARTICULAR PULLING UNIT OR PUSHING AID FOR A WHEELCHAIR OR INDUSTRIAL TRUCK

(75) Inventors: Heinrich PERK, Aglasterhausen (DE); Oliver KRETSCHMER, Sinsheim (Dueren) (DE); Brian HOEHN, Angelbachtal (DE)

(73) Assignee: OTTO BOCK MOBILITY SOLUTIONS GMBH, Konigsee (DE)

(21) Appl. No.: 13/104,169

(22) Filed: May 10, 2011

(30) Foreign Application Priority Data
May 10, 2010 (DE) 10 2010 020 318.1

(51) Int. Cl. G05G 1/04; G05G 1/01; G05G 1/00

(52) U.S. Cl. 74/484 R; 74/491

(57) ABSTRACT

The invention relates to an operating unit (10) for vehicles driven by an electric motor, with a housing (1) for accommodating the mechanical components of the control electronics or the like, at least one actuating element (2a, 2b) which is arranged on the housing (1), is capable of being pivoted relative thereto, is arranged on a hollow shaft (11) mounted in the housing (1) and is capable of being detached from the hollow shaft (11) without the use of tools in such a way that its position on the hollow shaft (11) can be adjusted by virtue of rotating the actuating element (2a, 2b).

The invention relates to an operating unit for vehicles driven by an electric motor, in particular for a pulling unit or a pushing aid for a wheelchair or for an industrial truck.

DE 10 2006 016 568 B4 has disclosed a pushing aid for a wheelchair which has at least one driving wheel driven by an electric motor and a handlebar for introducing steering operations. The drive motor of the pushing aid can be driven via an operating device fixed to the handlebar, it being possible for the operating direction to be actuated by the handlebar being pivoted. This operating device is designed in such a way that, when the handlebar is pivoted downwards, the drive motor is driven for forwards travel. The pushing aid is coupled to the wheelchair from the rear thereof and can then be actuated by an attendant. In principle, such a pushing aid can also be used as a pulling aid. In this case, it is not coupled to the rear of the wheelchair, but to the front. The wheelchair can then be driven by the person sitting in said wheelchair with external-force actuation.

A pulling unit for a wheelchair is disclosed for example in U.S. Pat. No. 7,117,967 B2.

DE 20 2007 001 486 U1 has disclosed a modular coupling system for optionally coupling a drive and/or steering unit to a wheelchair.

Pulling devices and pushing aids are intended to be used with a conventional wheelchair which has two outer handrims provided on the drive wheels of said wheelchair, it being possible for the wheelchair to be moved forwards or backwards using said handrims by means of arm power. This type of driving requires both of the driver's hands. In particular in the case of relatively long travel distances, driving using the handrims can be very strenuous for the wheelchair user or for a person pushing the wheelchair, with the result that electrical drive aids for the locomotion of wheelchairs have been developed.

DE 101 41 566 C1 has disclosed an operating unit for a drive apparatus for driving a conveying means, in particular an electrically drivable wheelchair. This operating unit is provided with an actuating element, which has an actuation path with at least two predetermined operating positions, wherein, in a first operating position the drive power of the drive apparatus is equal to zero and, when a second predetermined operating position is reached, a maximum value is reached. If the actuating element is actuated beyond the second predetermined operating position, the drive power of the drive apparatus is altered, with it being necessary for a predetermined actuating force to be exceeded in order to overshoot the second predetermined operating position.

DE 2002 21 073 U1 discloses a pushing aid for a wheelchair, which has an operating element with an actuating element, which is in a zero position in the non-actuated state. In this zero position, the drive power of the pushing aid is equal to zero. If the actuating element is actuated counter to a spring force, the drive power increases as the actuation path increases. When the entire actuation path is utilized, i.e. the actuating element has reached a stop, the maximum drive power is provided.

DE 10 2004 005 762 A1 describes a tiller head for an industrial truck, which has an operating unit with a plurality of modes, wherein at least one adjusting wheel is connected to a proportional switch and the proportional switch can also be connected, inter alia, to a driving mode controller. The driving mode controller is used in this case for controlling a movement of the industrial truck itself in the environment. Monitored lifting and lowering of the load pickup means is performed via a lifting controller.

An industrial truck a so-called “Ameise”, is operated by different people in a manufacturing facility. If the pushing aid for a wheelchair is used by different people or the pushing aid is also used as a pulling unit, the operating unit or the actuating elements need(s) to be matched to the ergonomics of the different people, which is tiresome not merely because tools are required for this purpose.

Starting from this problem, the intention is to improve an operating unit for vehicles driven by an electric motor such that the setting of said operating unit can be matched easily to different users or drivers of the vehicle.

In order to solve the problem, the operating unit is provided with a housing for accommodating the mechanical components of the control electronics or the like and at least one actuating element, which is arranged on the housing, is capable of being pivoted relative thereto, is arranged on a hollow shaft mounted in the housing and is capable of being detached from the hollow shaft without the use of tools in such a way that its position on the hollow shaft can be altered by rotating the actuating element.

This configuration means that the relative position of the housing, i.e. of the core of the operating unit, is independent of the relative position of the actuating element(s), with the result that the arrangement of the actuating element can be adjusted by the respective user optimally with respect to his requirements.

The at least one actuating element is preferably arranged laterally on the housing.

Advantageously, two actuating elements are provided, which are formed identically and in mirror-image fashion and can be arranged laterally on the housing on both sides on in each case one hollow shaft.

The two hollow shafts are then preferably coupled to one another, with the result that the actuation of only one actuating element is transferred to the other.

In order to be able to detach the actuating element from the hollow shaft easily, the hollow shaft is preferably provided with external toothing and the actuating element with internal toothing corresponding thereto. This configuration makes it possible for the actuating element to be displaced axially on the hollow shaft until the external toothing and the internal toothing come out of engagement. Then, owing to the fact that it is no longer connected to the hollow shaft in a manner fixed against rotation, the actuating element can be pivoted and, when the desired position of the operating element has been reached, can be pushed back onto the external toothing of the hollow shaft.

In order to simplify the process of pushing back the actuating element, the axial displacement of the actuating element preferably takes place counter to the force of a spring, which is tensioned in the process, with the result that, as the strain is relieved on the spring, the spring pushes the actuating element back onto the external toothing of the hollow shaft.

For simple fastening of the operating unit to the tiller of the pulling/pushing aid or of the industrial truck, means for fixed clamping are provided on the lower side of the housing. Preferably, the operating unit is fixedly clamped on a tube, namely a handlebar, as is known from bicycles, for example.

An exemplary embodiment of the invention will be described in more detail below with the aid of a drawing, in which:

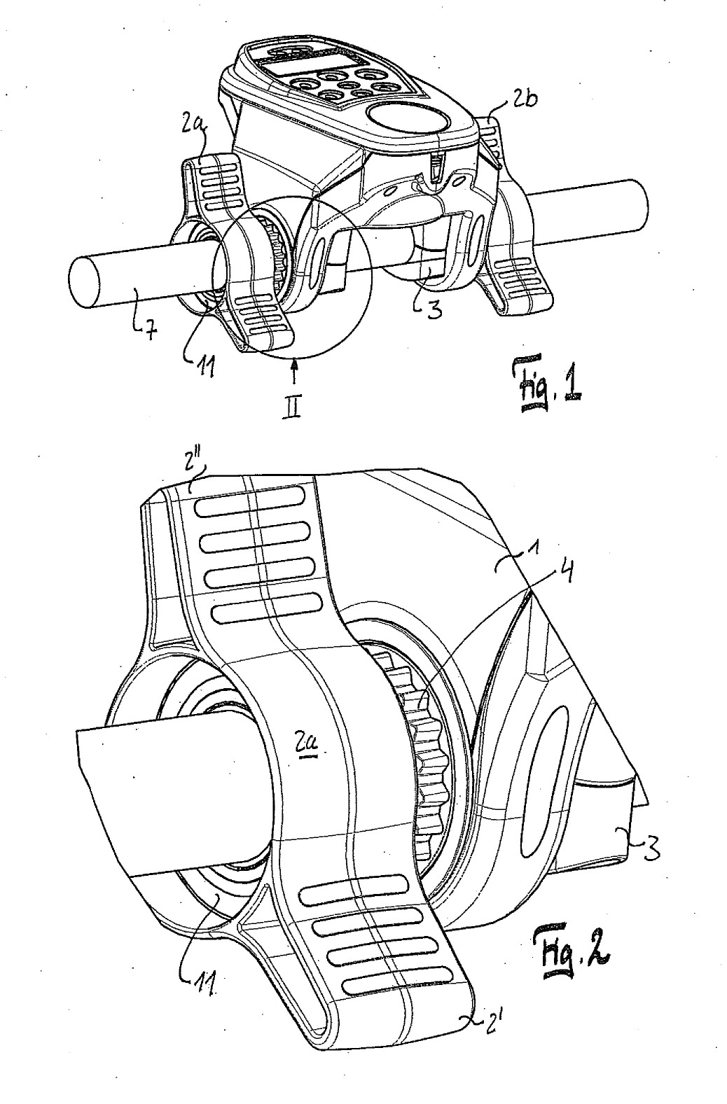

FIG. 1 shows the operating unit in a first perspective view;

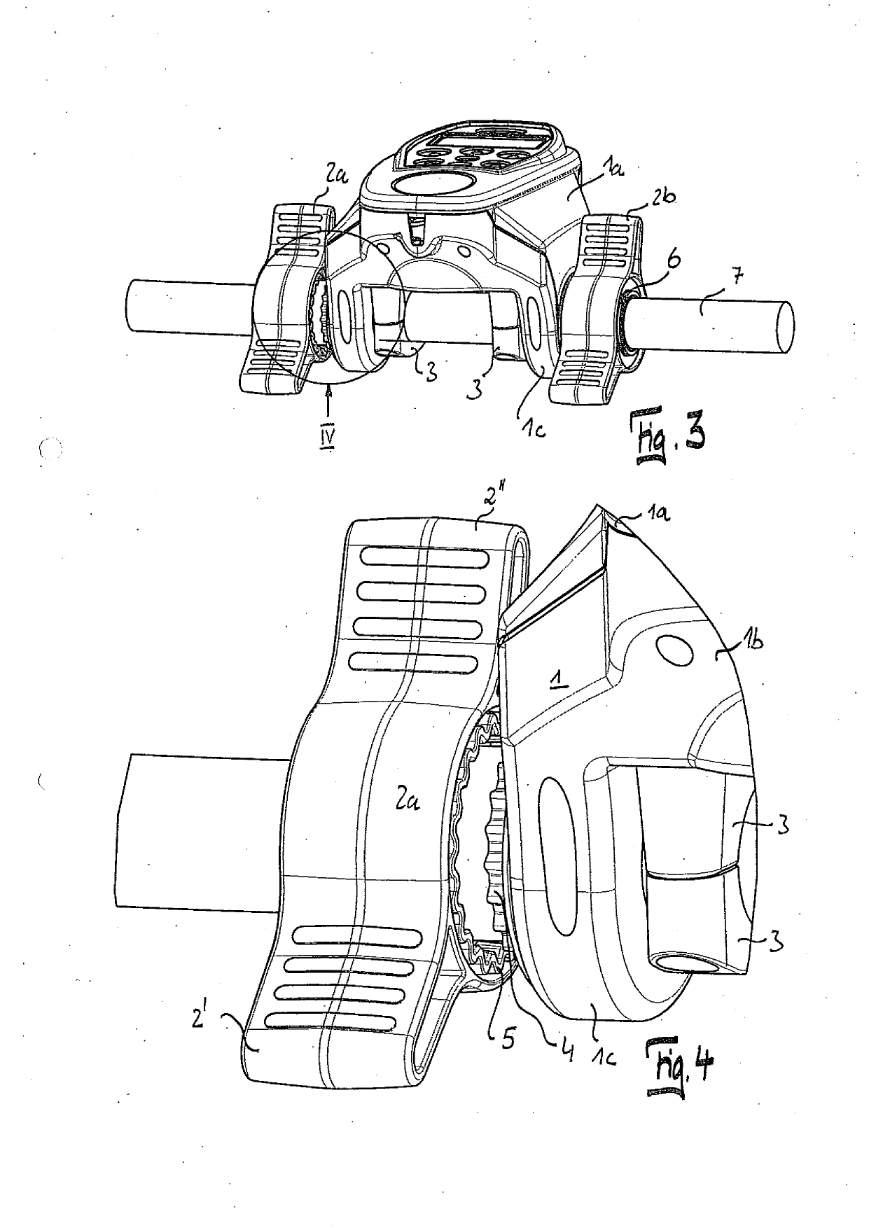

FIG. 2 shows the enlarged illustration of the detail II shown in FIG. 1;

FIG. 3 shows the operating unit in a second perspective view;

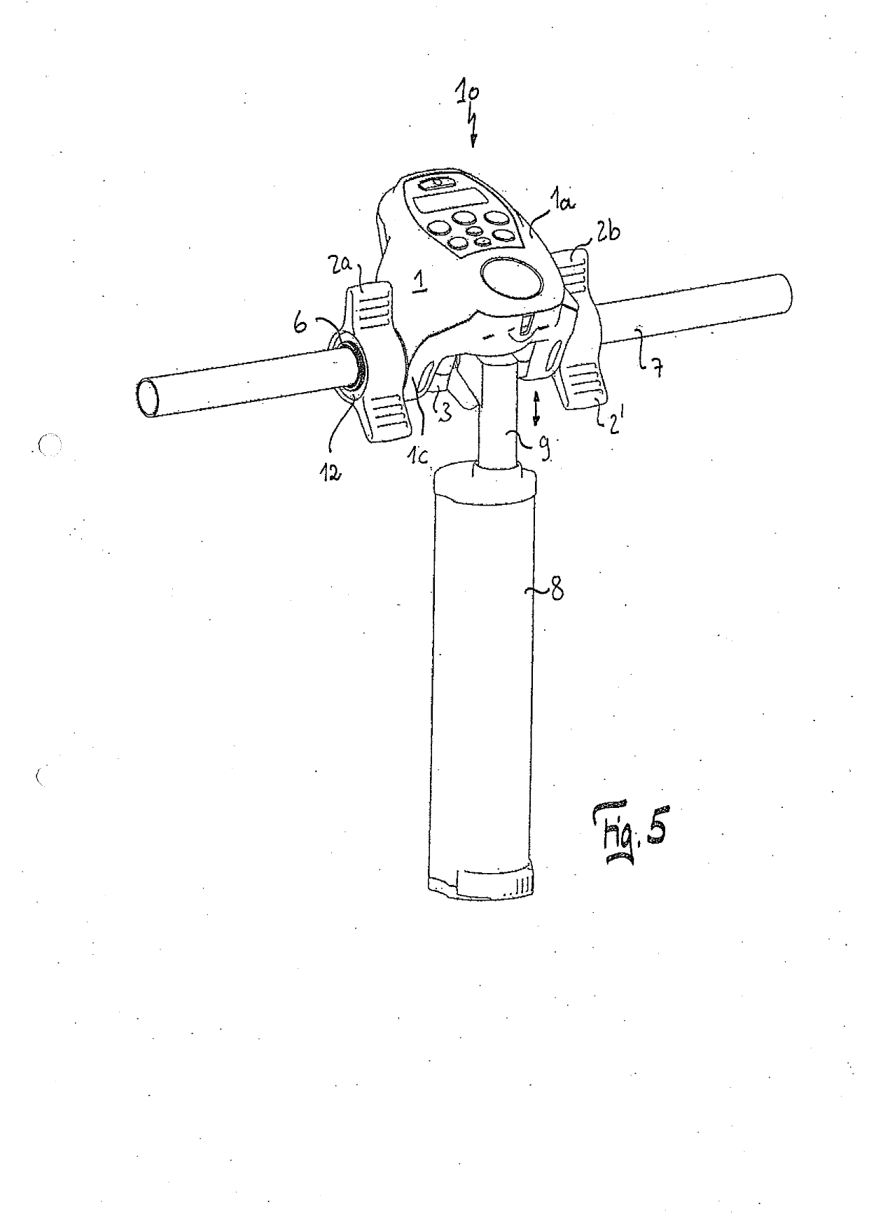

FIG. 4 shows the enlarged illustration of the detail IV shown in FIG. 3;

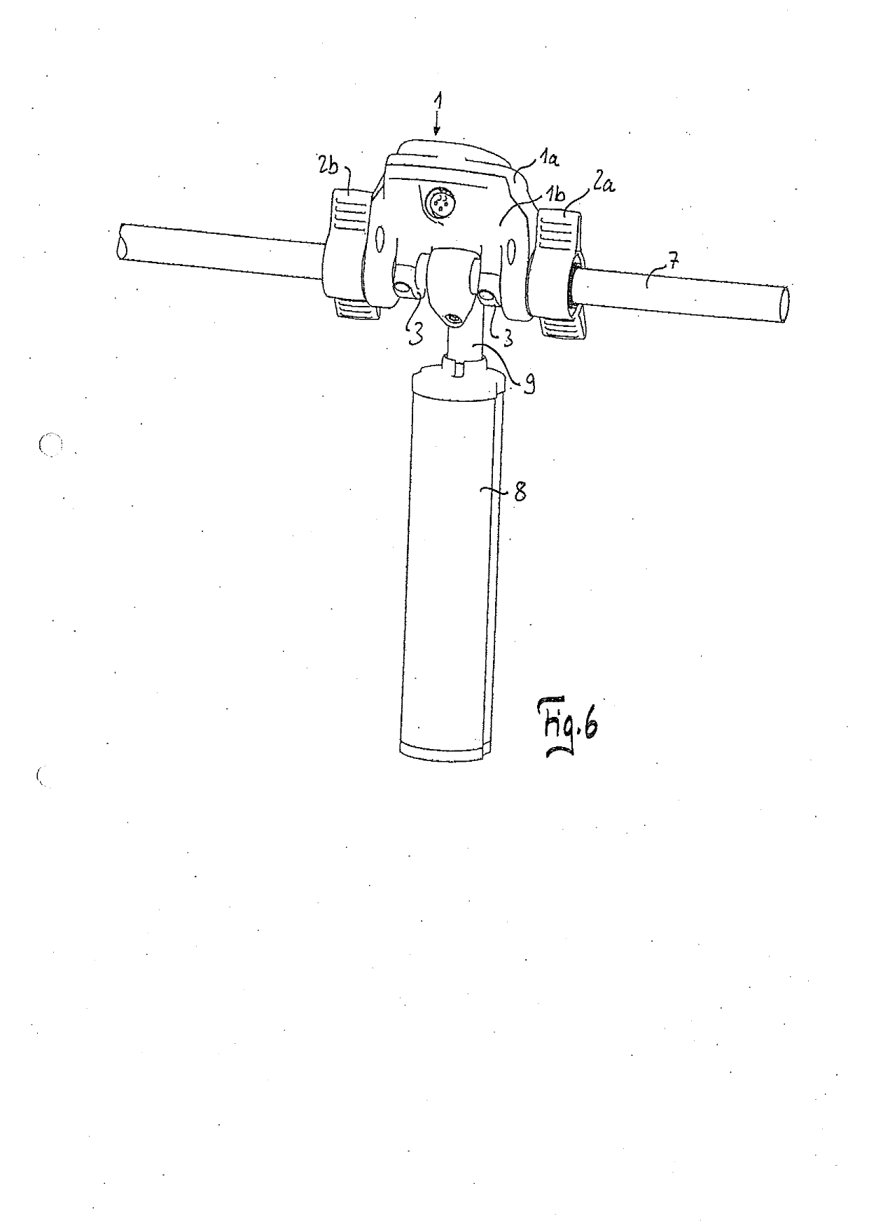

FIG. 5 shows the operating unit fitted on the tiller from the front side in a perspective illustration;

FIG. 6 shows the operating unit fitted on the tiller from the rear side in a perspective illustration.

The operating unit 10 comprises the closed plastic housing 1, which is provided on its upper side 1a with a plurality of openings (not designated in any more detail here), in order to accommodate switching elements and/or indicator lights and a display device. The housing 1 is formed in two parts, with the result that the upper side 1a can be separated from the lower side 1b. The operating unit 10 is clamped fixedly on the tube 7 forming the handlebar via clamping elements 3 provided on the lower side 1b. The steering column 7 is connected to the tiller 8 and is vertically adjustable continuously, as is indicated by the double arrow in FIG. 5, via a front structure 9, as is known from bicycle construction, for example. The operating unit 10 can be used for various vehicles. Its preferred use is for a pushing aid or a pulling aid for a wheelchair. It is also conceivable for a combined pulling and pushing aid for a wheelchair to be used by changing the position of the tiller 8. Likewise, the operating unit 10 can be used for an electric wheelchair or for an industrial truck, a so-called Ameise.

In each case one hollow shaft 11 is mounted rotatably in the two downwardly guided limbs 1c of the housing 1, said hollow shaft being provided with external toothing 4 at its housing-side end. An annular stop 12 is provided at the opposite end of the hollow shaft 11, said stop being fastened axially on the hollow shaft 11 by means of a snap ring 6. The two hollow shafts 11 are coupled rigidly to one another in the interior of the housing 1 via a clip (not illustrated), with the result that a pivoting movement of one hollow shaft 11 is transferred to the opposite hollow shaft 11.

The wing-shaped actuating elements 2a, 2b are provided with internal toothing 5 corresponding to the external toothing 4 of the hollow shaft 11. The actuating elements 2a, 2b positioned on the hollow shaft 11 can be displaced in the axial direction as far as against the stop 12 (cf. FIG. 5) counter to the force of a spring (not shown). If the actuating elements 2a, 2b bear against the stop 12 associated respectively therewith, their internal toothing 5 is out of engagement with the external toothing 4, the hollow shaft 11 and the actuating elements 2a, 2b are freely rotatable in any direction with respect to the steering column 7. As a result, the actuating elements 2a, 2b can be adjusted in such a way that they are arranged in optimal fashion for the user once the operating unit has previously been fixed on the tube 7 in such a way that it has an optimum position in the field of vision of a user. The number of teeth in the toothing 4, 5 determines the smallest angle about which the operating elements 2a, 2b can be rotated with respect to the housing 1 and fixed again.

For example, the speed and the direction of travel of the vehicle are predetermined via the actuating elements 2a, 2b. If one of the actuating elements 2a or 2b is rotated forwards by the operator's thumb, the hollow shafts 11, which are coupled to one another and are connected to a potentiometer arranged in the housing 1, are pivoted and, corresponding to the rotary angle position, the vehicle begins to travel in the forwards direction. If the actuating elements 2a, 2b are pressed downwards (see FIG. 1), the vehicle picks up speed for a reversing travel corresponding to the adjusted rotary angle. The two wings 2′, 2″ of the actuating elements 2a, 2b are arranged at an angle of approximately 160° with respect to one another.

The operating unit 10 including the hollow shaft 11 and the operating levers 2a, 2b is preferably manufactured from plastic. The two housing halves 1a, 1b are screwed to one another. A spring is arranged between the hollow shaft 11 and the actuating elements 2a, 2b respectively arranged in axially displaceable fashion on said hollow shaft, said spring being tensioned when the actuating levers 2a, 2b come out of engagement with the external toothing 4 of the hollow shaft 11, which ensures that the actuating elements 2a, 2b are automatically moved back when the toothings 4, 5 come to overlap one another and the actuating elements 2a, 2b are released. The actuating elements are adjustable independently of one another in terms of their angular position with respect to the housing 1, as can be seen from FIGS. 2 and 4. Only the hollow shafts 11 are mechanically coupled to one another.

The operating unit can be used for a pulling/pushing aid for a wheelchair or else for an industrial truck, for example an “Ameise”.

1. An operating unit (10) for vehicles driven by an electric motor, with a housing (1) for accommodating the mechanical components of the control electronics or the like, at least one actuating element (2a, 2b), which is arranged on the housing (1), is capable of being pivoted relative thereto, is arranged on a hollow shaft (11) mounted in the housing (1) and is capable of being detached from the hollow shaft (11) without the use of tools in such a way that its position on the hollow shaft (11) can be adjusted by virtue of rotating the actuating element (2a, 2b).

2. The operating unit (10) as claimed in claim 1, wherein the at least one actuating element (2a, 2b) is arranged laterally on the housing (1).

3. The operating unit (10) as claimed in claim 1 or 2, wherein two actuating elements (2a, 2b) are provided.

4. The operating unit (10) as claimed in one of the preceding claims, wherein the hollow shaft (11) is provided with external toothing (4) and the actuating element (2a, 2b) is provided with internal toothing (5) corresponding thereto.

5. The operating unit (10) as claimed in one of the preceding claims, wherein the actuating element (2a, 2b) is arranged in axially displaceable fashion on the hollow shaft (11).

6. The operating unit (10) as claimed in claims 4 and 5, wherein the actuating element (2a, 2b) is displaceable axially on the hollow shaft (11) to such an extent that the external toothing (4) and the internal toothing (5) come out of engagement.

7. The operating unit (10) as claimed in claim 3, wherein the actuating elements (2a, 2b) are formed symmetrically.

8. The operating unit (10) as claimed in claim 3 or 7, wherein the actuating elements (2a, 2b) are arranged laterally on the housing (1) on both sides.

9. The operating unit (10) as claimed in one of claims 3 to 8, wherein each actuating element (2a, 2b) is arranged on a hollow shaft (11).

10. The operating unit (10) as claimed in claim 9, wherein the two hollow shafts (11) are coupled mechanically to one another.

11. The operating unit (10) as claimed in claim 2 or 3, wherein the actuating element (2a, 2b) is in the form of wings, and the distance between the wings (2′, 2″) is 160°.

12. The operating unit (10) as claimed in claim 5, wherein the actuating element (2a, 2b) is displaceable counter to the force of a spring.

13. The operating unit (10) as claimed in one of the preceding claims, wherein means for fixed clamping on a tube (7), in particular a steering column, are provided on the lower side (1b) of the housing (1).

14. A vehicle driven by an electric motor having an operating unit (10) as claimed in one of the preceding claims.

15. The vehicle driven by an electric motor as claimed in claim 11, wherein the vehicle is a pulling unit and/or a pushing aid for a wheelchair.

16. The vehicle driven by an electric motor as claimed in claim 11, wherein the vehicle is an industrial truck.
